(19) United States
(12) Patent Application Publication
(10) Pub. No.: US 2024/0125653 A1
(43) Pub. Date: Apr. 18, 2024

(54) IN-SITU DARK CURRENT MEASUREMENT FOR PYROMETER

(71) Applicant: General Electric Company, Schenectady, NY (US)

(72) Inventors: Emad Andarawis Andarawis, Ballston Lake, NY (US); Aaron Jay Knobloch, Niskayuna, NY (US)

(21) Appl. No.: 17/964,127

(22) Filed: Oct. 12, 2022

(51) Int. Cl. G01J 5/14; F01D 21/00; G01J 5/00; G01J 5/04

(52) U.S. Cl. CPC G01J 5/14; F01D 21/003; G01J 5/0088; G01J 5/042; F05D 2270/804

(57) ABSTRACT

Techniques for using a pyrometer to measure one or more operating characteristics of a target are provided. In one example aspect, a pyrometer is oriented relative to a target having target elements spaced from one another such that, as the target is rotated, the pyrometer alternately i) senses a target element for a period of time; and ii) then does not sense any of the target elements for a period of time as no appreciable signal is received. The pyrometer generates an output signal having alternating target pulse widths and null widths. The target and null widths have different amplitudes. The amplitude of the null signal provides an amplitude baseline for which the amplitudes of the target widths or signals may be compared to so that a temperature or other operating characteristic associated with the target can be determined.

### FEDERALLY SPONSORED RESEARCH

This invention was made with Government support under contract number N00014-10-D-0010 awarded by the Department of Navy. The Government has certain rights in this invention.

### FIELD

The present disclosure relates to pyrometers, such as pyrometers that may be used in-situ or during operation of a gas turbine engine.

### BACKGROUND

Pyrometers can provide a non-contact means for measuring temperature of certain target objects, such as a rotating airfoil array of a gas turbine engine. Conventionally, pyrometers used for measuring temperature of elements of gas turbine engines have had certain limitations. For instance, the temperature that a pyrometer can measure at lower target temperatures is governed by Plank's law. Thus, the number of photons received by the pyrometer drops steeply at lower target temperatures, which brings the target signal level down to a similar level as the dark current, or current generated in a detector of a pyrometer even when no photons enter the detector. Error in estimating and subtracting the dark current from the target signal drives the signal-to-noise ratio, which ultimately limits the ability of the pyrometer to measure low level target temperatures. Modeling dark current has also proven to be difficult as temperature increases, namely because dark current is an exponential function of temperature.

### BRIEF DESCRIPTION OF THE DRAWINGS

A full and enabling description of the present disclosure, including the best mode thereof, directed to one of ordinary skill in the art, is set forth in the specification, which makes reference to the appended figures, in which:

FIG. 1 provides a schematic, cross-sectional view of a gas turbine engine according to example embodiments of the present disclosure;

FIG. 2 provides a flow diagram for a method of determining an operating characteristic of a target using a pyrometer according to one example embodiment of the present disclosure;

FIG. 3 provides a perspective view of a pyrometer positioned relative to an example target embodied as a rotating airfoil array of a gas turbine engine according to one example embodiment of the present disclosure;

FIG. 4 provides a schematic view of the pyrometer of FIG. 3 sensing an operating characteristic of the target at a first time as the target is rotated;

FIG. 5 provides a schematic view of the pyrometer of FIG. 3 sensing an operating characteristic of the target at a second time as the target is rotated;

FIG. 6 provides a graph depicting an output signal generated by the pyrometer of FIG. 3 as the target is rotated;

FIG. 7 provides a graph depicting the output signal generated by the pyrometer of FIG. 3 and temperature measurements calculated based on the output signal;

FIG. 8 provides a data flow diagram for a control system according to one example embodiment of the present disclosure;

FIG. 9 provides a data flow diagram for another control system according to one example embodiment of the present disclosure;

FIG. 10 provides a graph depicting a Signal-to-Noise Ratio (SNR) that can be achieved with a pyrometer and the teachings of the present disclosure compared to an SNR that can be achieved with a pyrometer and conventional techniques;

FIG. 11 provides a diagram showing implementation of a Fast Fourier Transform to convert an output signal of a pyrometer into a frequency domain signal according to one example embodiment of the present disclosure;

FIG. 12 provides a schematic view of a pyrometer sensing a target having alternating target elements and baseline elements as the target is rotated; and

FIG. 13 provides a computing system according to example embodiments of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The singular forms “a”, “an”, and “the” include plural references unless the context clearly dictates otherwise.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “HP” and “LP” refer to high pressure and low pressure, respectively. The high pressure elements noted herein are subjected to higher pressures relative to the low pressure elements noted herein.

The present disclosure relates to pyrometers that may be used in-situ or during operation of a gas turbine to sense an operating characteristic of a target, such as a temperature of a rotating airfoil array, a variable geometry vane, or static component. With conventional pyrometers, measuring the temperature of elements of gas turbine engines has presented certain challenges. At lower target temperatures, such as a low target temperature of a rotating airfoil array, the number of photons emitted by the target is lower, and consequently, a detector of the pyrometer senses less photons. This results in a lower signal level, which negatively affects the signal aspect of a signal-to-noise ratio, or SNR. Moreover, at lower signal levels, the target signal will approach the level of the dark current, making identification and subtraction of the dark current from the target signal difficult. In addition, at higher pyrometer temperatures, the detector generates more dark current, or electric current not associated with photons emitted by the target. Accordingly, more noise is generated at higher pyrometer temperatures. This negatively affects the noise aspect of SNR. To determine an accurate temperature measurement, the dark current is subtracted from the target signal, but error in estimating the dark current has proven difficult, namely because dark current is an exponential function of temperature.

Accordingly, in accordance with the inventive aspects of the present disclosure, techniques for using a pyrometer to accurately measure one or more operating characteristics of a target even despite the difficulties with dark current is provided herein. In one example aspect, a pyrometer is oriented relative to a target having target elements spaced from one another such that, as the target is rotated, the pyrometer alternately i) senses a target element for a period of time; and ii) then does not sense any of the target elements for a period of time as no appreciable signal is received. Thus, the pyrometer generates an output signal having alternating target pulse widths and null widths, or alternating target and null signals. The target and null widths are at different amplitudes. The null signal provides an amplitude baseline for which the amplitudes of the target widths or signals may be compared to so that a temperature or other operating characteristic can be determined. The amplitude of the null signal is essentially representative of the dark current and directly measured during operation at the pyrometer temperature of that instance. Thus, the null signal is advantageous in that the need to model or estimate the dark current associated with the detector may be eliminated or otherwise reduced. Modeling dark current has proven challenging to do. Moreover, the need for a separate detector or pyrometer for estimating the dark current may be eliminated or otherwise reduced.

As one example, a detector of the pyrometer can use high bandwidth electronics (e.g., up to 150 kHz) to sort out the null signals from the actual target signals or widths. In one embodiment, the pyrometer signal is digitized with a high sample rate digitizer that is determined by the number of blades in the particular stage multiplied by the speed of the rotation and the number of points per blade that is desired to be resolved. The in-situ dark signal measurements, or amplitude of the null signals or widths, and the amplitude of the actual target signal or widths can be sent to a calculation module so that the dark current, or amplitude of the null signal, can be subtracted off the amplitude of the actual target signal or widths to determine the temperature of the target. As another example, a low sampling rate system can implement a target hold function and a null hold function to hold an amplitude of the target pulse widths or signals and the amplitude of the null widths or signals. The held signals can be digitized and used to determine the temperature of the target at reduced data rates, or the computation can be performed directly on the held values in the analog domain prior to digitization. Further, in another example aspect, a rotational speed of a target can be determined using an output signal having alternating target pulse widths and null widths, the target pulse widths having distinctly different amplitudes than the null widths. A fast Fourier transform can be used to convert the output signal into a frequency domain signal to determine a frequency that corresponds with a pulse of interest. The frequency can then be mapped to a rotational speed of the target. In another embodiment, the number of nulls and target signals are counted within a known time window to determine speed.

An output signal generated by a pyrometer with alternating target pulse widths and null widths provides certain advantages, benefits, and technical effects. For instance, such an output signal enables enhanced sensing at lower target temperatures, because the amplitudes of the target pulse widths or signals are more clearly delineated from the amplitudes of the null widths or signals, which correspond with the dark current. This allows for temperature sensing at some flame-on measurements. Moreover, such an output signal enables enhanced sensing at higher pyrometer temperatures because the amplitudes of the null signals or widths act as a baseline for the dark current, and thus, the amplitudes of the target pulse widths can be compared to an accurate representation of the dark current for determining the temperature, rather than an estimation or prediction of the dark current via a model, for example. With an accurate measurement of the dark current, cooling systems typically employed for pyrometers can be eliminated or otherwise scaled down in size, which provides weight savings and additional packaging space, and/or the pyrometer can be used in higher ambient temperature environments. In addition, a pyrometer of the present disclosure can enable measurements of operating characteristics besides temperature, such as rotational speed. This can reduce the number of sensors needed or provide sensor redundancy.

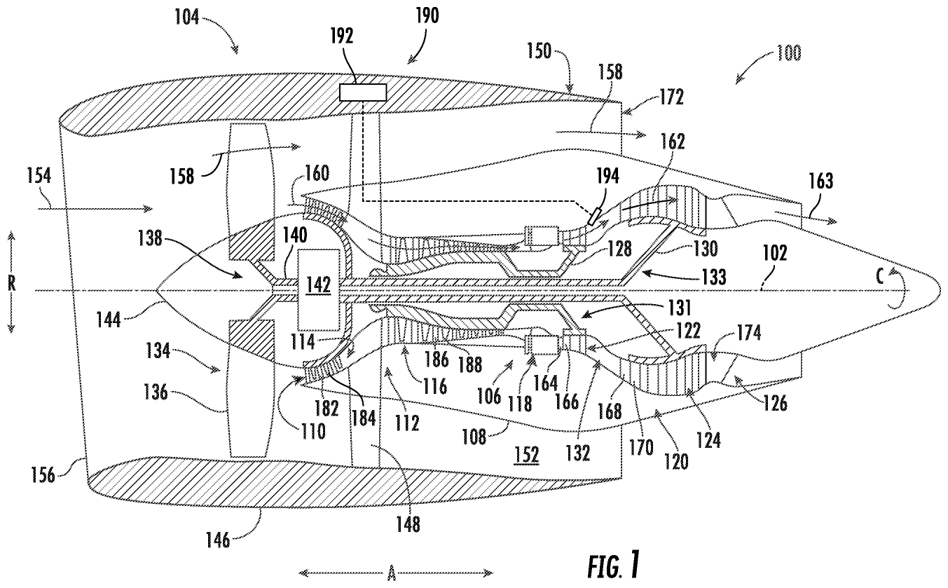

Referring now to the drawings, FIG. 1 provides a schematic, cross-sectional view of a gas turbine engine 100 according to example embodiments of the present disclosure. For the depicted embodiment of FIG. 1, the gas turbine engine 100 is an aeronautical, high-bypass turbofan engine configured to be mounted to an aircraft, e.g., in an under-wing configuration. As shown, the gas turbine engine 100 defines an axial direction A, a radial direction R, and a circumferential direction C. The axial direction A extends parallel to or coaxial with a longitudinal centerline 102 defined by the gas turbine engine 100.

The gas turbine engine 100 includes a fan section 104 and a core turbine engine 106 disposed downstream of the fan section 104. The core turbine engine 106 includes an engine cowl 108 that defines an annular core inlet 110. The engine cowl 108 encases, in a serial flow relationship, a compressor section 112 including a first, booster or LP compressor 114 and a second, HP compressor 116; a combustion section 118; a turbine section 120 including a first, HP turbine 122 and a second, LP turbine 124; and an exhaust section 126. The compressor section 112, combustion section 118, turbine section 120, and exhaust section 126 together define a core air flowpath 132 through the core turbine engine 106.

An HP shaft 128 drivingly connects the HP turbine 122 to the HP compressor 116. An LP shaft 130 drivingly connects the LP turbine 124 to the LP compressor 114. The HP shaft 128, the rotating components of the HP compressor 116 that are mechanically coupled with the HP shaft 128, and the rotating components of the HP turbine 122 that are mechanically coupled with the HP shaft 128 collectively form a high pressure spool, or HP spool 131. The LP shaft 130, the rotating components of the LP compressor 114 that are mechanically coupled with the LP shaft 130, and the rotating components of the LP turbine 124 that are mechanically coupled with the LP shaft 130 collectively form a low pressure spool, or LP spool 133.

The fan section 104 includes a fan assembly 138 having a fan 134 mechanically coupled with a fan rotor 140. The fan 134 has a plurality of fan blades 136 circumferentially-spaced apart from one another. As depicted, the fan blades 136 extend outward from the fan rotor 140 along the radial direction R. A power gearbox 142 mechanically couples the LP spool 133 and the fan rotor 140. The power gearbox 142 may also be called a main gearbox. The power gearbox 142 includes a plurality of gears for stepping down the rotational speed of the LP shaft 130 to provide a more efficient rotational fan speed of the fan 134. In other example embodiments, the fan blades 136 of the fan 134 can be mechanically coupled with a suitable actuation member configured to pitch the fan blades 136 about respective pitch axes, e.g., in unison. In some alternative embodiments, the gas turbine engine 100 does not include the power gearbox 142. In such alternative embodiments, the fan 134 can be directly mechanically coupled with the LP shaft 130, e.g., in a direct drive configuration.

Referring still to FIG. 1, the fan rotor 140 and hubs of the fan blades 136 are covered by a rotatable spinner 144 aerodynamically contoured to promote an airflow through the plurality of fan blades 136. An outer nacelle 146 circumferentially surrounds the fan 134 and/or at least a portion of the core turbine engine 106. The outer nacelle 146 is supported relative to the core turbine engine 106 by a plurality of circumferentially-spaced outlet guide vanes 148. A downstream section 150 of the outer nacelle 146 extends over an outer portion of the core turbine engine 106 so as to define a bypass passage 152 therebetween.

During operation of the gas turbine engine 100, a volume of air 154 enters the gas turbine engine 100 through an associated inlet 156 of the outer nacelle 146 and/or the fan section 104. As the volume of air 154 passes across the fan blades 136, a first portion of air 158 is directed or routed into the bypass passage 152 and a second portion of air 160 is directed or routed into the core inlet 110. The pressure of the second portion of air 160 is progressively increased as it flows downstream through the LP compressor 114 and HP compressor 116. Particularly, the LP compressor 114 includes sequential stages of LP compressor stator vanes 182 and LP compressor blades 184 that progressively compress the second portion of air 160. The LP compressor blades 184 are mechanically coupled to the LP shaft 130. Similarly, the HP compressor 116 includes sequential stages of HP compressor stator vanes 186 and HP compressor blades 188 that progressively compress the second portion of air 160 even further. The HP compressor blades 188 are mechanically coupled to the HP shaft 128. The compressed second portion of air 160 is then discharged from the compressor section 112 into the combustion section 118.

The compressed second portion of air 160 discharged from the compressor section 112 mixes with fuel and is burned within a combustor of the combustion section 118 to provide combustion gases 162. The combustion gases 162 are routed from the combustion section 118 along a hot gas path 174 of the core air flowpath 132 through the HP turbine 122 where a portion of thermal and/or kinetic energy from the combustion gases 162 is extracted via sequential stages of HP turbine stator vanes 164 and HP turbine blades 166. The HP turbine blades 166 are mechanically coupled to the HP shaft 128. Thus, when the HP turbine blades 166 extract energy from the combustion gases 162, the HP shaft 128 rotates, thereby supporting operation of the HP compressor 116. The combustion gases 162 are routed through the LP turbine 124 where a second portion of thermal and kinetic energy is extracted from the combustion gases 162 via sequential stages of LP turbine stator vanes 168 and LP turbine blades 170. The LP turbine blades 170 are coupled to the LP shaft 130. Thus, when the LP turbine blades 170 extract energy from the combustion gases 162, the LP shaft 130 rotates, thereby supporting operation of the LP compressor 114, as well as the fan 134 by way of the power gearbox 142.

The combustion gases 162 exit the LP turbine 124 and are exhausted from the core turbine engine 106 through the exhaust section 126 to provide propulsive thrust. Simultaneously, the pressure of the first portion of air 158 is substantially increased as the first portion of air 158 is routed through the bypass passage 152 before the first portion of air 158 is exhausted from a fan nozzle exhaust section 172 of the gas turbine engine 100, also providing propulsive thrust. The HP turbine 122, the LP turbine 124, and the exhaust section 126 at least partially define the hot gas path 174.

It will be appreciated that the gas turbine engine 100 depicted in FIG. 1 is provided by way of example, and that in other example embodiments, the gas turbine engine 100 may have other configurations. Additionally, or alternatively, aspects of the present disclosure may be utilized with any other suitable aeronautical turbofan engine, such as a turboshaft engine, turboprop engine, turbojet engine, etc. Moreover, the aspects of the present disclosure may apply to other turbomachinery, such as ground-based power generating gas turbine engines and steam turbines.

As further shown in FIG. 1, the gas turbine engine 100 includes a Full Authority Digital Electronic Control system (or FADEC system 190) that provides control of the gas turbine engine 100. The FADEC system 190 includes, among other things, an engine controller 192 and a plurality of sensors communicatively coupled with the engine controller 192. The sensors can be communicatively coupled with engine controller 192 via one or more wired or wireless communication links, for example. The sensors are configured to sense operating characteristics of the gas turbine engine 100. The outputs of the sensors can be routed to the engine controller 192 for real time control of the gas turbine engine 100. Example operating characteristics can include, without limitation, various speeds, pressures, temperatures, etc. at different stations or points along the gas turbine engine 100.

For the depicted embodiment of FIG. 1, the sensors of the FADEC system 190 include a pyrometer 194 positioned adjacent to a rotating array of airfoils, which in this example embodiment is a rotating array of HP turbine blades 166 of the second stage of the HP turbine 122. The pyrometer 194 can sense one or more operating characteristics of the HP turbine blades 166, such as a temperature thereof. The pyrometer 194 can include a lens or focuses device, a near-infrared (Near-IR) detector, and electronics, such as a transimpedance amplifier, to convert the detector output current to voltage. The pyrometer 194 can be a multicolor pyrometer or a single color pyrometer, for example. In accordance with the inventive aspects of the present disclosure, improved techniques for using a pyrometer to measure one or more operating characteristics of a rotating target having a plurality of target elements, such as a rotating array of airfoils of a gas turbine engine, will be provided below.

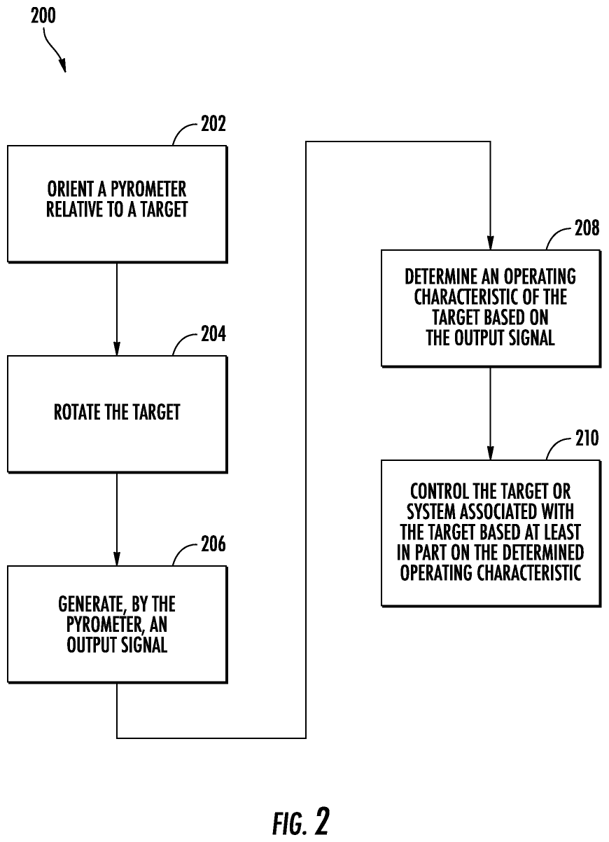

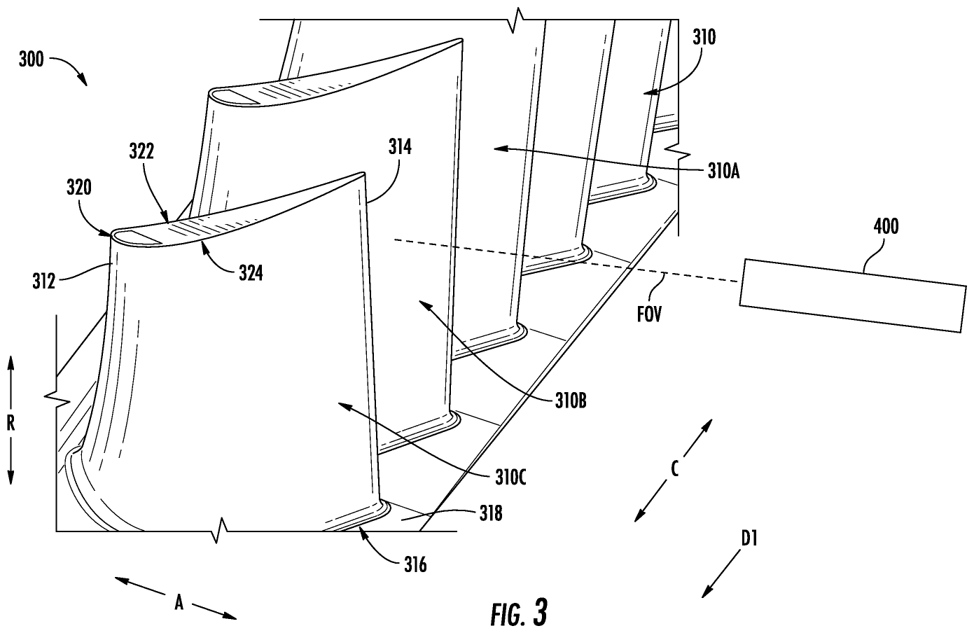

With reference now to FIGS. 2, 3, 4, and 5, FIG. 2 provides a flow diagram for a method 200 of determining an operating characteristic of a target using a pyrometer according to one example embodiment of the present disclosure. To provide context to the method 200, FIGS. 3 through 11 will also be referenced below.

At 202, the method 200 includes orienting a pyrometer relative to a target having target elements spaced from one another. At 204, the method 200 includes rotating the target about an axis of rotation. Particularly, at 202, the pyrometer is oriented relative to the target so that, as the target is rotated about the axis of rotation at 204, a field of view of the pyrometer alternately engages and then does not engage the target elements. That is, the pyrometer is oriented at 202 so that, as the target is rotated at 204, the pyrometer iteratively i) senses a given one of the target elements for a period of time; and ii) then does not sense the given target element or any other target element for a period of time. This process iterates as each target element of the target passes by the pyrometer.

In some embodiments, the target defines an axial direction, a radial direction, and a circumferential direction. The target rotates in a first direction about the circumferential direction. In some example embodiments, the target elements are angled with respect to the axial direction. For instance, in some embodiments, the target elements can be angled so that each target element is oriented at least within forty-five degrees (45°) of perpendicular to the axial direction. In other embodiments, the target elements are arranged so that a greatest length of each target element extends along the circumferential direction. That is, so that each target element extends the longest along the circumferential direction. In yet other embodiments, the target elements are arranged so that, for each adjacent pair of target elements, a leading edge of one target element of the adjacent pair overlaps with a trailing edge of the other target element of the adjacent pair along the circumferential direction.

By way of example, FIG. 3 provides a perspective view of a pyrometer 400 positioned relative to an example target embodied as a rotating airfoil array 300 of a gas turbine engine. The target includes target elements, which are embodied as airfoils 310 that are circumferentially spaced apart from one another. The target, or rather the airfoil array 300 in this example, is rotatable about an axis of rotation, e.g., a longitudinal centerline of a gas turbine engine. For this example embodiment, the airfoils 310 are high pressure turbine blades, but in other example embodiments, the airfoils 310 can be compressor blades, low pressure turbine blades, or other elements of a rotating array, for example.

As shown in FIG. 3, for reference, the airfoil array 300 defines an axial direction A, a radial direction R, and a circumferential direction C. The airfoils 310 of the airfoil array 300 include, among others, a first airfoil 310A, a second airfoil 310B positioned adjacent the first airfoil 310A, and a third airfoil 310C positioned adjacent the second airfoil 310B. Each one of the airfoils 310 has a leading edge 312, a trailing edge 314, a root 316 coupled with a platform 318, and a blade tip 320. Each one of the airfoils 310 also has a first or pressure side 322 and a second or suction side 324. In FIG. 3, a Field of View (FOV) of the pyrometer 400 is shown engaging the suction side 324 of the second airfoil 310B. The FOV of the pyrometer 400 is its area of measurement or sensing region.

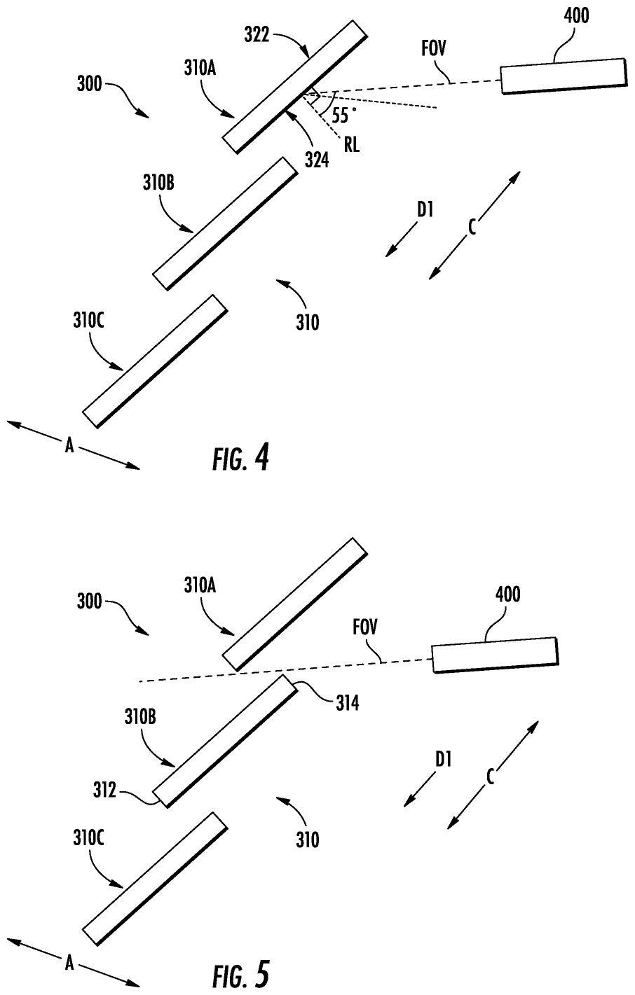

Further, for this embodiment, the airfoils 310 are angled with respect to the axial direction A. For instance, the airfoils 310 are angled so that each one of the airfoils 310 is oriented at least within forty-five degrees (45°) of perpendicular to the axial direction A. Further, for this embodiment, the airfoils 310 are angled with respect to the axial direction A so that a greatest length of each one of the airfoils 310 extends along the circumferential direction C. That is, so each one of the airfoils 310 extends the longest along the circumferential direction C. Moreover, for this embodiment, the airfoils 310 of the airfoil array 300 are arranged so that, for each adjacent pair of airfoils 310, the leading edge 312 of one airfoil of the adjacent pair overlaps with a trailing edge 314 of the other airfoil of the adjacent pair along the circumferential direction C (as shown also in FIGS. 4 and 5).

With reference now to FIGS. 4 and 5 in addition to FIGS. 2 and 3, FIG. 4 provides a schematic view of the pyrometer 400 sensing the airfoil array 300 at a first time as the rotating airfoil array 300 is rotated about the axis of rotation. FIG. 5 provides a schematic view of the pyrometer 400 sensing the airfoil array 300 at a second time as the rotating airfoil array 300 is rotated about the axis of rotation, the second time being later in time than the first time.

As depicted in FIG. 4, the pyrometer 400 is oriented relative to the rotating airfoil array 300 such that, when a given one of the airfoils 310 is in the FOV, the FOV of the pyrometer 400 is at least within fifty-five degrees (55°) of a reference line RL that is perpendicular to a surface of interest of the given one of the airfoils 310. The surface of interest is the surface desired to be sensed. As shown in FIG. 4, the first airfoil 310A is in the FOV of the pyrometer 400 at this particular point in time, or at the first time. The surface of interest in this instance is the suction side 324 of the first airfoil 310A. As shown, the FOV of the pyrometer 400 is at fifty-five degrees) (55°) of the reference line RL that is perpendicular to the suction side 324, or the surface of interest. Having the FOV of the pyrometer 400 at least within fifty-five degrees (55°) of a reference line that is perpendicular to a surface of interest of the given one of the airfoils 310 passing by the pyrometer 400 facilitates a stronger signal-noise-ratio.

As depicted in FIG. 5, the airfoil array 300 has rotated along the circumferential direction C in a first direction D1 along the circumferential direction C relative to its position in FIG. 4. In this instance, or at the second time, none of the airfoils 310 of the airfoil array 300 are in focus or in the FOV of the pyrometer 400. As shown, the FOV of the pyrometer 400 is shown passing between, but not engaging, the first airfoil 310A and the second airfoil 310B. In this regard, at the second time, none of the airfoils 310 are being sensed by the pyrometer 400.

As the airfoil array 300 continues to rotate along the circumferential direction C in the first direction D1 from its position in FIG. 5, the FOV of the pyrometer 400 will engage or come into focus with the second airfoil 310B for a period of time (e.g., as shown in FIG. 3). The FOV of the pyrometer 400 will first engage the trailing edge 314 of the second airfoil 310B and then work its focus along the suction side 324 until the FOV of the pyrometer 400 eventually engages the leading edge 312 of the second airfoil 310B. As the airfoil array 300 continues to rotate, the FOV of the pyrometer 400 will then not engage any of the airfoils 310 for a period of time as the FOV passes between the second airfoil 310B and the third airfoil 310C, will then engage or come into focus with the third airfoil 310C for a period of time, and so on for the remaining airfoils 310 of the airfoil array 300. Accordingly, at 202, the pyrometer 400 is oriented relative to the airfoil array 300 so that, as the airfoil array 300 is rotated about the axis of rotation at 204, the FOV of the pyrometer 400 alternately engages and then does not engage the airfoils 310. Stated differently, the pyrometer 400 is oriented at 202 so that, as the airfoil array 300 is rotated at 204, the pyrometer 400 iteratively i) senses a given one of the airfoils 310 for a period of time; and ii) then does not sense any of the airfoils 310 for a period of time. Accordingly, the orientation of the pyrometer 400 relative to the airfoil array 300 effectively causes the pyrometer 400 to generate an output signal with intermittent null widths as will be explained below.

At 206, with reference still to FIGS. 2 through 5, the method 200 includes generating, by the pyrometer, an output signal. Specifically, at 206, the method 200 includes generating, by a pyrometer as the target is rotated about the axis of rotation, an output signal having alternating target pulse widths and null widths. The target pulse widths of the output signal correspond to periods of time in which a given target element is in the FOV of the pyrometer while the null widths of the output signal correspond to periods of time in which none of the target elements are in the FOV of the pyrometer.

Continuing with the example from above, FIG. 6 provides a graph depicting an output signal 500 generated by the pyrometer 400 as the airfoil array 300 is rotated about the axis of rotation. The output signal 500 is shown as a function of time in FIG. 5. The amplitude of the output signal 500, or pyrometer output, can be a voltage or electric current, for example. As shown, the output signal 500 includes alternating target pulse widths 502 and null widths 504. The target pulse widths 502 of the output signal 500 correspond to periods of time in which a given one of the airfoils 310 is in the FOV of the pyrometer 400 while the null widths 504 of the output signal 500 correspond to periods of time in which none of the airfoils 310 are in the FOV of the pyrometer 400. The target pulse widths 502 have amplitudes that are distinctly different than the amplitudes of the null widths 504.

Specifically, a first target pulse width TPW1 of the output signal 500 corresponds to a period of time in which the FOV of the pyrometer 400 engages the first airfoil 310A (e.g., as shown in FIG. 4). The amplitude of the output signal 500 at the rising edge of the first target pulse width TPW1 is less than the amplitude of the output signal 500 at the falling edge, because, as a given one of the airfoils 310 rotates past the pyrometer 400, the FOV of the pyrometer 400 engages or focuses on the trailing edge 314 of the given airfoil 310 first and engages the leading edge 312 of the given airfoil 310 last. As will be appreciated, for high pressure turbine blades, the leading edges of the blades are hotter than the trailing edges of the blades. The output signal 500 also includes a first null width NW1 that corresponds to a period of time in which the FOV of the pyrometer 400 does not engage any of the airfoils 310 (e.g., as shown in FIG. 5), a second target pulse width TPW2 that corresponds to a period of time in which the FOV of the pyrometer 400 engages the second airfoil 310B (e.g., as shown in FIG. 3), a second null width NW2 that corresponds to a period of time in which the FOV of the pyrometer 400 does not engage any of the airfoils 310 (the FOV passes between but does not engage the second airfoil 310B or the third airfoil 310C), and a third target pulse width TPW3 that corresponds to a period of time in which the FOV of the pyrometer 400 engages the third airfoil 310C. It will be appreciated that the output signal 500 will continue to be generated in this alternating pattern as the airfoil array 300 continues to be rotated about the axis of rotation.

At 208, the method 200 includes determining one or more operating characteristics of the target based at least in part on the output signal. The one or more operating characteristics can include a temperature of the target, and as will be explained further below, the one or more operating characteristics can include a rotational speed of the target. Rotational speed of a target has not conventionally been determined by way of a pyrometer, which is a known temperature sensing device.

In implementations in which the operating characteristic of the target is or includes a temperature of the target, determining the temperature of the target at 208 based at least in part on the output signal, or rather the amplitudes of the target pulse widths and the amplitudes of the null widths thereof, includes determining a difference between an amplitude of a first null width of the null widths and an amplitude of a first target pulse width of the target pulse widths that is adjacent the first null width, the difference indicating the temperature of the target. In some embodiments, a single temperature data point is determined for each adjacent pair of target pulse width and null width. In such embodiments, the amplitude of the first target pulse width can be determined or taken as at least one of an average amplitude of the first target pulse width, a maximum amplitude of the first target pulse width, a minimum amplitude of the first target pulse width, or a median of the first target pulse width. In other embodiments, multiple temperature data points can be determined for a given target pulse width. For instance, a minimum amplitude and a maximum amplitude of a target pulse width can be compared to an amplitude of an adjacent null width. In this regard, two (2) temperature data points can be generated for a given target pulse width. In other embodiments, more than two (2) temperature data points can be calculated for a given target pulse width. In other embodiments the standard deviation of the amplitudes can be computed and utilized to assess the temperature uniformity or the noise performance of the system.

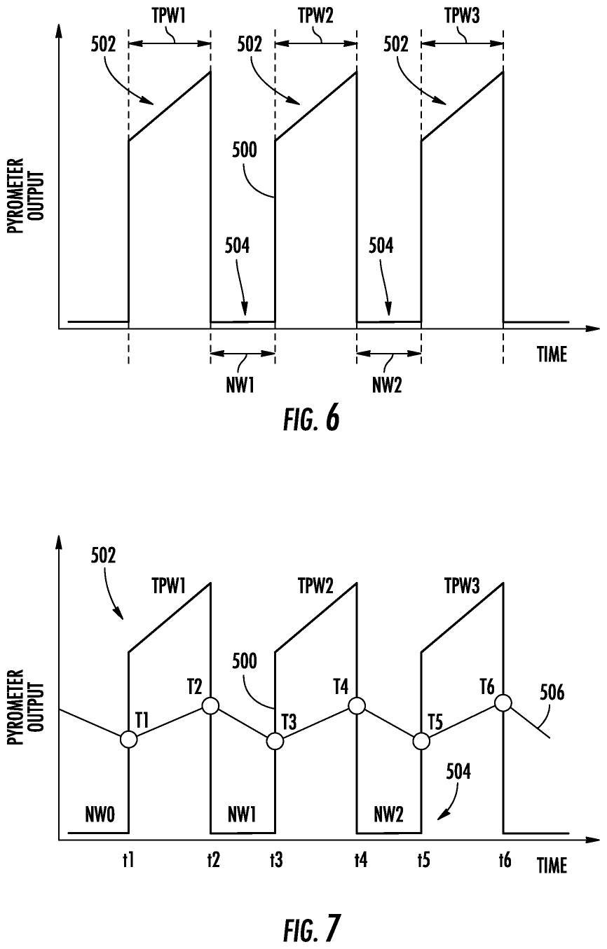

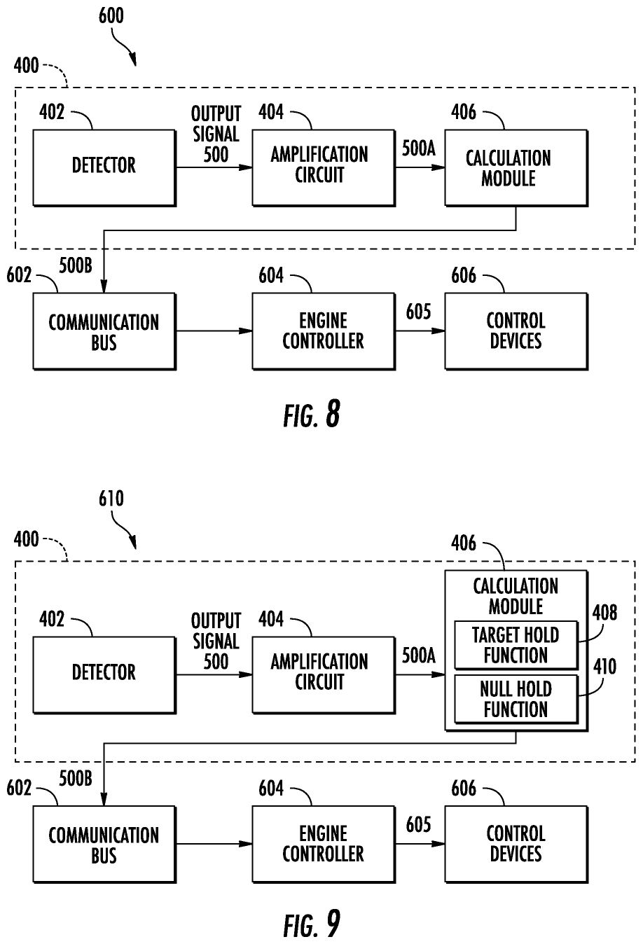

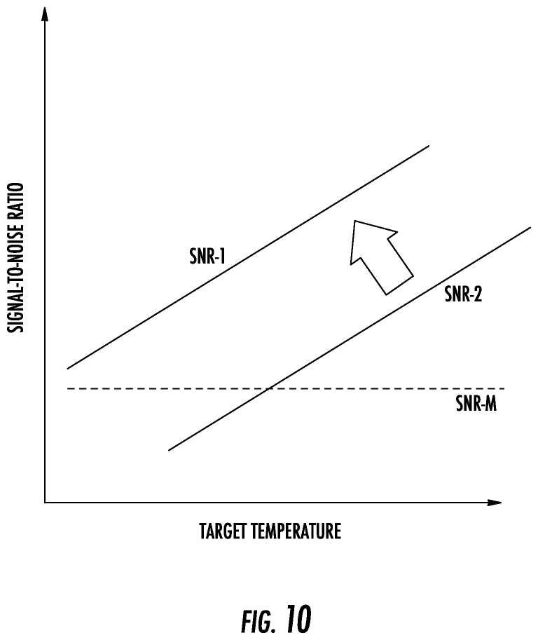

Continuing with the example above and with reference now to FIG. 7, the temperature of the airfoil array 300 can be calculated, e.g., by a calculation module 406 described in connection with FIGS. 8 and 9, by determining a difference between an amplitude of the first null width NW1 of the null widths 504 and an amplitude of the first target pulse width TPW1 of the target pulse widths 502 that is adjacent the first null width NW1. For this example, the multiple temperature data points are determined for a given target pulse width. Particularly, the amplitude (or y-axis value) of the output signal 500 during a zeroth null width NW0 is subtracted from the amplitude (or y-axis value) of the output signal 500 at time t1. This subtraction operation effectively subtracts the dark current from the portion of the output signal 500 that corresponds to the sensed first airfoil 310A. The difference indicates a temperature measurement or temperature T1 of the first airfoil 310A, or, more particularly, the trailing edge 314 of the first airfoil 310A, at time t1. By using an amplitude of a null width for comparison to an amplitude of a target pulse width a temperature measurement (e.g., T1) can be determined with high accuracy because the dark current is accurately represented by the amplitude of the null width. In this instance, for example, a temperature measurement T1 can be determined with high accuracy by comparing the amplitude of the zeroth null width NW0 to the amplitude of the first target pulse width TPW1 at time t1. Further, the amplitude of the output signal 500 during the zeroth null width NW0 is subtracted from the amplitude of the output signal 500 at time t2. This difference indicates a temperature T2 of the first airfoil 310A, or, more particularly, the leading edge 312 of the first airfoil 310A, at time t2.

This process can be repeated for each target pulse width 502. For calculating temperature data points associated with the second target pulse TPW2, the amplitude of the output signal 500 during the first null width NW1 is subtracted from the amplitude of the output signal 500 at time t3. This difference indicates a temperature T3 of the second airfoil 310B, or more particularly the trailing edge 314 of the second airfoil 310B, at time t3. The amplitude of the output signal 500 during the first null width NW1 is also subtracted from the amplitude of the output signal 500 at time t4. This difference indicates a temperature T4 of the second airfoil 310B, or, more particularly, the leading edge 312 of the second airfoil 310B, at time t4.

For calculating temperature data points associated with the third target pulse TPW3, the amplitude of the output signal 500 during the second null width NW2 is subtracted from the amplitude of the output signal 500 at time t5. This difference indicates a temperature T5 of the third airfoil 310C, or more particularly the trailing edge 314 of the third airfoil 310C, at time t5. The amplitude of the output signal 500 during the second null width NW2 is also subtracted from the amplitude of the output signal 500 at time t6. This difference indicates a temperature T6 of the third airfoil 310C, or more particularly the leading edge 312 of the third airfoil 310C, at time t6. The temperature data points T1 through T6, as well as others, can collectively form a dark current-corrected temperature signal 506.

In some other embodiments, instead of calculating a temperature data points with a null width that precedes a given target pulse, a null width that follows or occurs subsequent to a given target pulse width can be used for temperature calculation purposes. For instance, the amplitude of the first null width NW1 can be compared to one or more amplitudes of the first target pulse width TPW1 to determine one or more temperature data points, wherein the first null width NW1 occurs subsequent to the first target pulse width TPW1. In other embodiments, a number of null signal amplitudes are averaged together and used in the subtraction. In one example, the averaging is a rolling window average of the null signal amplitudes. The averaging window size can be chosen to be short in duration compared to the time scale of the detected temperature change, and therefore remaining indicative of the dark current of the detector within the measurement window.

At 210, as shown in FIG. 2, the method 200 can include controlling the target or system associated with the target based at least in part on the determined one or more operating characteristics of the target. In this regard, improved temperature measurements captured by the pyrometer can be used to control the target or a system associated with the target.

Continuing with the example above and with reference to FIG. 8 in addition to FIGS. 2 through 7, FIG. 8 provides a data flow diagram for a control system 600. The control system 600 can be a FADEC system of a gas turbine engine for an aircraft, for example. As depicted in FIG. 8, the pyrometer 400 includes, among other possible components, a detector 402, an amplification circuit 404, and a calculation module 406 embodied as a high speed Analog-to-Digital Converter (ADC). The detector 402 can be a Near-IR detector operable to detect or capture photons emitted by the target, or in this example embodiment, the airfoil array 300. The detector 402 can output or generate the output signal 500 in the manner explained above. The output signal 500 can optionally be passed through the amplification circuit 404, which amplifies the output signal 500. The amplified output signal 500A is routed to the calculation module 406 for processing. The calculation module 406 can convert the amplified output signal 500A, which is in analog form, to one or more digital operating characteristic measurements 500B, e.g., the temperatures T1, T2, T3, T4, T5, and T6 measured shown in FIG. 7.

The one or more digital operating characteristic measurements 500B can be routed over a communication bus 602, e.g., to an engine controller 604. The engine controller 604 can receive the one or more digital operating characteristic measurements 500B, and can control the airfoil array 300 or system associated with the airfoil array 300 based at least in part on the one or more digital operating characteristic measurements 500B. For instance, the engine controller 604 can be communicatively coupled with one or more control devices 606. The engine controller 604 can control the one or more control devices 606, e.g., to change an operating point of the gas turbine engine in which the airfoil array 300 is disposed. The engine controller 604 can send one or more control commands 605 to the one or more control devices 606 for control thereof. The one or more control commands 605 can be generated by the engine controller 604 based at least in part on the one or more digital operating characteristic measurements 500B. The one or more control devices 606 can include, without limitation, one or more valves, variable geometry components (e.g., variable pitch stator vanes, variable pitch fan blades, etc.), pumps, a combination of the foregoing, etc. that may be controlled by the engine controller 604.

As one example, based on the one or more of the temperature measurements T1, T2, T3, T4, T5, and T6, the engine controller 604 can control one or more of the control devices 606 to adjust an operating point of the gas turbine engine in which the airfoil array 300 is disposed. For instance, when the temperature measurements T1, T2, T3, T4, T5, and T6 indicate that the airfoil array 300 or hot section of the gas turbine engine has exceeded a threshold, the engine controller 604 can control the one or more control devices 606 to reduce the fuel flow to the combustor of the gas turbine engine, which may ultimately reduce the operating temperature of the gas turbine engine. It will be appreciated that the engine controller 604 can perform other control actions based on the received the one or more digital operating characteristic measurements 500B. It will be further appreciated that the one or more digital operating characteristic measurements 500B can be stored in the engine controller 604 or other recording device for other purposes as well, such as lifing and prognostic health management of the airfoil array 300 and/or gas turbine engine generally. For instance, the digital operating characteristic measurements 500B can be tracked over time, and the rate of change of the digital operating characteristic measurements 500B can be used to perform a lifing analysis (e.g., a Remaining Useful Life (RUL)) on the airfoil array 300 and/or gas turbine engine generally. Additionally or alternatively, the digital operating characteristic measurements 500B can be tracked over time and trended into the future for prognostic health management of the airfoil array 300 and/or gas turbine engine.

In some other embodiments, instead of utilizing a high speed ADC for the calculation module 406 as in the control system 600 of FIG. 8, a relatively low sampling rate system may be implemented. FIG. 9 provides a data flow diagram for a control system 610. The control system 610 is configured and may operate in a similar manner as the control system 600 of FIG. 8, except as provided below. In another embodiment, the target and null amplitude values are captured using analog circuits, and the subtraction can also be performed in the analog domain. The null-subtracted output of the pyrometer can be presented to, e.g. a controller of a FADEC system, as an analog signal, for instance as a voltage or current proportional to temperature.

For the depicted embodiment of FIG. 9, the calculation module 406 includes a target hold function 408 and a null hold function 410. As shown, the optionally amplified output signal 500A may be routed to the calculation module 406. The target hold function 408 can be implemented to hold an amplitude of one of the target pulse widths 502. Similarly, the null hold function 410 can be implemented to hold an amplitude of one of the null widths 504. The operating characteristic of the target, such as a temperature of the airfoil array 300, can be determined based at least in part on the amplitude of the one target pulse width held by the target hold function 408 and the amplitude of the one null width held by the null hold function 410. The sampling or measurement determinations based on the held signals or widths of the output signal 500 (or the amplified output signal 500A) may allow for significant reduction in data rates, and consequently, less processing power.

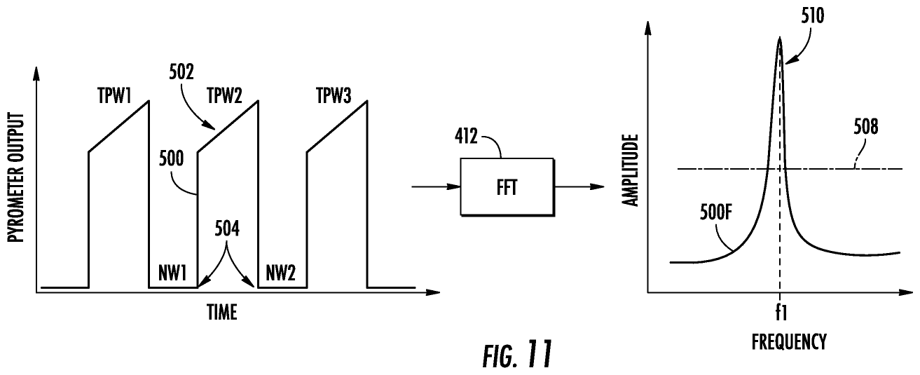

FIG. 10 provides a graph depicting a Signal-to-Noise Ratio (SNR) that can be achieved with a pyrometer and the teachings of the present disclosure compared to an SNR that can be achieved with a pyrometer and conventional techniques. As depicted in FIG. 10, an SNR-1 corresponding to an SNR that can be achieved with a pyrometer and the teachings of the present disclosure is shown as a function of target temperature. A minimum signal-to-noise ratio, or SNR-M, is shown. Notably, SNR-1 exceeds the minimum signal-to-noise ratio SNR-M even at lower target temperatures. In comparison, an SNR-2 corresponding to an SNR that can be achieved with a pyrometer and conventional techniques does not provide a sufficient SNR at lower target temperatures. Accordingly, a pyrometer and the teachings of the present disclosure can provide an enhanced SNR even at lower target temperatures, and as illustrated, a higher SNR at all target temperatures compared to conventional techniques.

In some further implementations of the method 200, at 208, the operating characteristic of the target can be or include a rotational speed of the target. Accordingly, in addition or alternatively to the temperature of the target, a rotational speed of the target can be used for controlling the target or system associated with the target at 210.

With reference now to FIG. 11 in addition to FIGS. 2 through 9, in determining the rotational speed of the target based at least in part on the target pulse widths and the null widths of the output signal at 208, the method 200 can include implementing a Fast Fourier Transform (FFT), or FFT 412, to convert the output signal 500 (or the amplified output signal 500A) into a frequency domain signal 500F as shown in FIG. 11. The periods of time or widths of the target pulse widths 502 and the null widths 504 can allow the FFT 412 to determine the frequency at which the airfoils 310 pass by the pyrometer 400, and the FFT 412 can use this data to output the frequency domain signal 500F.

Further, once the frequency domain signal 500F is generated, the method 200 can include determining a frequency of the frequency domain signal 500F that corresponds with a pulse of interest that has an amplitude greater than a predetermined magnitude 508. For this example, one pulse of the frequency domain signal 500F exceeds the predetermined magnitude 508, and therefore, the pulse that exceeds the predetermined magnitude 508 is deemed the pulse of interest 510. The frequency corresponding to the pulse of interest 510 is determined. In this example, the frequency that corresponds to the pulse of interest 510 is f1. The predetermined magnitude 508 can be a fixed value or can be variable, e.g., based on the operating point of the gas turbine engine in which the airfoil array 300 is disposed.

The method 200 can also include determining the rotational speed of the target based at least in part on the frequency that corresponds to the pulse of interest 510. For instance, for the depicted embodiment of FIG. 11, the frequency f1 is used to determine the rotational speed of the airfoil array 300. A lookup table, model, or other technique can be utilized to map the frequency f1 to the rotational speed of the airfoil array 300. A calculation module can perform the mapping, and the rotational speed of the airfoil array 300 can be routed over a communication bus to an engine controller. The engine controller can then control one or more control devices based at least in part on the rotational speed of the airfoil array 300.

In other implementations, speed is determined by counting the number of target elements and/or null intervals within a given time duration and determining the speed by computing the number of target element passes per time unit (e.g., seconds). Particularly, in some example implementations, the method 200 can include counting a number of the target pulse widths and/or a number of null widths that occur within a defined time period and determining the rotational speed of the airfoil array based at least in part on the number of the target pulse widths and/or the number of null widths that occur within the defined time period.

A pyrometer output signal having alternating target pulse widths and null widths enables a pyrometer to not only determine the temperature of a target, but additionally or alternatively, a rotational speed of the target. The width of a given target pulse corresponds to a period of time in which the FOV of the pyrometer engages or has a given target element in focus. The null widths flanking both sides of the given target pulse enable a determination of when one target element leaves the FOV and when an adjacent target element comes into the FOV. Accordingly, the unique characteristics of the output signal enable an FFT to convert the time-domain output signal into a frequency-domain output signal, which as noted above, can be used to determine a frequency corresponding to a pulse of interest, and the frequency corresponding to the pulse of interest can be mapped to a rotational speed of the target. Advantageously, with the pyrometer able to determine a rotational speed of a target, speed sensors, such as encoders, can be eliminated, which can reduce complexity and the weight of a gas turbine engine. Alternatively, the pyrometer and speed sensors can be used in conjunction with one another, e.g., for sensor redundancy.

The inventive aspects of the present disclosure can also apply or be used with targets that have target elements that alternate with baseline target elements. For instance, target elements can alternate with baseline elements that are coated with or formed of a material that has an emissivity that is low relative to the material of the target elements, e.g., at least ten times lower. In this regard, the baseline elements would effectively be the “spacing” or void between the target elements, and consequently, would correspond to the null widths in the generated output signal of a pyrometer.

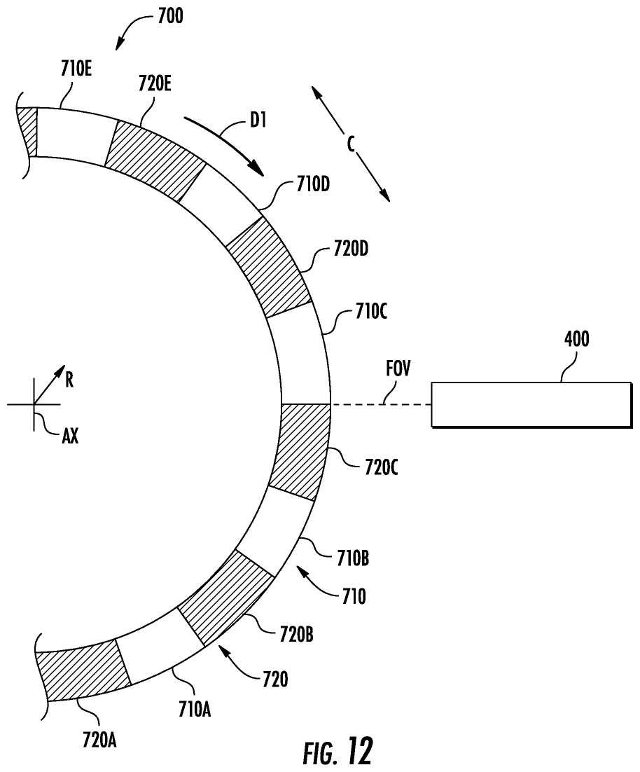

By way of example, FIG. 12 provides a schematic view of a pyrometer 400 sensing an operating characteristic of a target 700 having alternating target elements 710 and baseline elements 720 as the target 700 is rotated about an axis of rotation AX, e.g., in a first direction D1 along a circumferential direction C. The target elements 710 include target elements 710A, 710B, 710C, 710D, 710E, as well as others not depicted. The baseline elements 720 include baseline elements 720A, 720B, 720C, 720D, 720E, as well as others not depicted. As shown, the target elements 710A, 710B, 710C, 710D, 710E alternate with the baseline elements 720A, 720B, 720C, 720D, 720E. The target elements 710 are positioned adjacent to their respective baseline elements 720 without a space therebetween. In this regard, the target 700 has a continuous surface along its surface of interest that is exposed to the pyrometer 400. That is, there is no space or void between the alternating target elements 710 and baseline elements 720.

Accordingly, the field of view of the pyrometer alternately engages and does not engage the target elements 710, and, similarly, the field of view of the pyrometer alternately engages and does not engage the baseline elements 720. In some example embodiments, the baseline elements 720 are coated with or formed of a material that has an emissivity that is low relative to the material or coating of the target elements 710, e.g., at least ten times lower. In this regard, the target pulse widths of an output signal generated by the pyrometer 400 correspond to a time period in which the field of view FOV of the pyrometer 400 engages one of the target elements 710 and the null widths of the output signal generated by the pyrometer 400 correspond to a time period in which the field of view FOV of the pyrometer 400 engages one of the baseline elements 720. Accordingly, the baseline elements 720 enable the null widths or signals in the output signal. One or more operating characteristics associated with the target can be determined from such an output signal as noted herein.

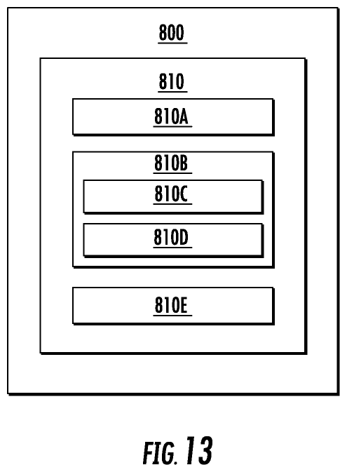

FIG. 13 provides a computing system 800 according to example embodiments of the present disclosure. The computing devices or elements described herein, such as the engine controllers 192, 604 and the pyrometers 194, 400, may include various components and perform various functions of the computing system 800 provided below.

The computing system 800 can include one or more computing device(s) 810. The computing device(s) 810 can include one or more processor(s) 810A and one or more memory device(s) 810B. The one or more processor(s) 810A can include any suitable processing device, such as a microprocessor, microcontroller, integrated circuit, logic device, and/or other suitable processing device. The one or more memory device(s) 810B can include one or more computer-executable or computer-readable media, including, but not limited to, non-transitory computer-readable medium, RAM, ROM, hard drives, flash drives, and/or other memory devices.

The one or more memory device(s) 810B can store information accessible by the one or more processor(s) 810A, including computer-readable instructions 810C that can be executed by the one or more processor(s) 810A. The instructions 810C can be any set of instructions that, when executed by the one or more processor(s) 810A, cause the one or more processor(s) 810A to perform operations. The instructions 810C can be software written in any suitable programming language or can be implemented in hardware. Additionally, and/or alternatively, the instructions 810C can be executed in logically and/or virtually separate threads on processor(s) 810A. The memory device(s) 810B can further store data 810D that can be accessed by the processor(s) 810A. For example, the data 810D can include models, lookup tables, databases, etc.

The computing device(s) 810 can also include a network interface 810E used to communicate, for example, with the other components of the computing system 800 (e.g., via a communication network). The network interface 810E can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

To summarize, an output signal generated by a pyrometer with alternating target pulse widths and null widths enables enhanced sensing at lower target temperatures, because the amplitudes of the target pulse widths or signals are more clearly delineated from the amplitudes of the null widths or signals, which correspond with the dark current. This allows for temperature sensing at some flame-on measurements. Moreover, such an output signal enables enhanced sensing at higher pyrometer temperatures because the amplitudes of the null signals or widths act as a baseline for the dark current, and thus, the amplitudes of the target pulse widths can be compared to an accurate representation of the dark current for determining the temperature, rather than an estimation or prediction of the dark current via a model, for example. With an accurate measurement of the dark current, cooling systems typically employed for pyrometers can be eliminated or otherwise scaled down in size, which provides weight savings and additional packaging space, and/or the pyrometer can be used in higher ambient temperature environments. In addition, a pyrometer of the present disclosure can enable measurements of operating characteristics besides temperature, such as rotational speed. This can reduce the number of sensors needed, which can reduce weight and cost, or provide sensor redundancy.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A method, comprising: generating, by a pyrometer as a target having target elements spaced from one another is rotated about an axis of rotation, an output signal having alternating target pulse widths and null widths; determining an operating characteristic of the target based at least in part on one or more amplitudes of the target pulse widths and one or more amplitudes of the null widths of the output signal; and performing a control action based at least in part on the operating characteristic of the target.

The method of any preceding clause, further comprising: orienting the pyrometer relative to the target so that, as the target is rotated about the axis of rotation, a field of view of the pyrometer alternately engages and does not engage the target elements, the target pulse widths being generated by the pyrometer when the field of view of the pyrometer engages one of the target elements and the null widths being generated by the pyrometer when the field of view of the pyrometer does not engage one of the target elements.

The method of any preceding clause, wherein the pyrometer is oriented relative to the target such that the field of view of the pyrometer is at least within fifty-five degrees (55°) perpendicular to a surface of interest of a given one of the target elements and so that the field of view of the pyrometer intermittently does not engage any of the target elements as the target is rotated about the axis of rotation.

The method of any preceding clause, wherein the operating characteristic of the target is a temperature of the target, and wherein determining the temperature of the target based at least in part on the one or more amplitudes of the target pulse widths and the one or more amplitudes of the null widths of the output signal comprises: determining a difference between an amplitude of a first null width of the null widths and an amplitude of a first target pulse width of the target pulse widths that is adjacent the first null width, the difference indicating the temperature of the target.

The method of any preceding clause, wherein the amplitude of the first target pulse width is taken as at least one of an average amplitude of the first target pulse width, a maximum amplitude of the first target pulse width, a minimum amplitude of the first target pulse width, or a median amplitude of the first target pulse width.

The method of any preceding clause, wherein the operating characteristic of the target is a temperature of the target, and wherein determining the temperature of the target based at least in part on the one or more amplitudes of the target pulse widths and the one or more amplitudes of the null widths of the output signal comprises: determining a first difference between an amplitude of a first null width of the null widths and a first amplitude of a first target pulse width of the target pulse widths that is adjacent the first null width, the first difference indicating the temperature of a trailing edge of a first target element of the target; and determining a second difference between the amplitude of the first null width and a second amplitude of the first target pulse width, the second difference indicating the temperature of a leading edge of the first target element of the target.

The method of any preceding clause, wherein the operating characteristic of the target is a rotational speed of the target, and wherein determining the rotational speed of the target based at least in part on the one or more amplitudes of the target pulse widths and the one or more amplitudes of the null widths of the output signal comprises: implementing a Fast Fourier Transform (FFT) to convert the output signal into a frequency domain signal; determining a frequency of the frequency domain signal that corresponds with a pulse of interest that has an amplitude greater than a predetermined magnitude; and determining the rotational speed of the target based at least in part on the frequency.

The method of any preceding clause, wherein determining the rotational speed of the target based at least in part on the one or more amplitudes of the target pulse widths and the one or more amplitudes of the null widths of the output signal comprises: counting a number of the target pulse widths and/or a number of null widths that occur within a defined time period; and determining the rotational speed of the target based at least in part on the number of the target pulse widths and/or the number of null widths that occur within the defined time period.

The method of any preceding clause, further comprising: implementing a target pulse width hold function to hold an amplitude of one of the target pulse widths; and implementing a null width hold function to hold an amplitude of one of the null widths, and wherein the operating characteristic of the target is determined based at least in part on the amplitude of the one target pulse width held by the target pulse width hold function and the amplitude of the one null width held by the null width hold function.

The method of any preceding clause, wherein the target is an array of a gas turbine engine and the target elements are airfoils of the array.

The method of any preceding clause, wherein the target elements are arranged so that, for each adjacent pair of the target elements, a leading edge of a first target element of the adjacent pair overlaps with a trailing edge of a second target element of the adjacent pair along a circumferential direction defined by the target.

The method of any preceding clause, wherein the target elements are arranged so that a greatest length of each target element extends along a circumferential direction defined by the target, the target being rotatable about the circumferential direction.

The method of any preceding clause, wherein performing the control action based at least in part on the operating characteristic of the target comprises controlling the target or a system associated with the target based at least in part on the operating characteristic of the target.

The method of any preceding clause, wherein performing the control action based at least in part on the operating characteristic of the target comprises: storing the operating characteristic of the target in one or more memory devices; and performing lifing and/or prognostic health management of the target and/or system associated with the target.

A non-transitory computer readable medium comprising computer-executable instructions, which, when executed by one or more processors, cause the one or more processors to: receive an output signal having alternating target pulse widths and null widths, the output signal being generated by a pyrometer as a target is rotated about an axis of rotation, the target having target elements spaced from one another; and determine an operating characteristic of the target based at least in part on one or more amplitudes of the target pulse widths and one or more amplitudes of the null widths of the output signal; and output the operating characteristic.

The non-transitory computer readable medium of any preceding clause, wherein the target has a plurality of baseline elements that alternate with the target elements, the baseline elements having a lower emissivity than the target elements.

The non-transitory computer readable medium of any preceding clause, wherein the pyrometer is oriented relative to the target so that, as the target is rotated about the axis of rotation, a field of view of the pyrometer alternately engages and does not engage the target elements, the target pulse widths being generated by the pyrometer when the field of view of the pyrometer engages one of the target elements and the null widths being generated by the pyrometer when the field of view of the pyrometer does not engage one of the target elements.

A control system for a gas turbine engine, the control system comprising: a pyrometer having a detector and a calculation module having one or more processors configured to: receive an output signal from the detector, the output signal having alternating target pulse widths and null widths and being generated by the detector as a target is rotated about an axis of rotation, the target having target elements spaced from one another, the pyrometer is oriented relative to the target so that, as the target is rotated about the axis of rotation, a field of view of the pyrometer alternately engages and does not engage the target elements, the target pulse widths being generated by the pyrometer when the field of view of the pyrometer engages one of the target elements and the null widths being generated by the pyrometer when the field of view of the pyrometer does not engage one of the target elements; determine an operating characteristic of the target based at least in part on one or more amplitudes of the target pulse widths and one or more amplitudes of the null widths of the output signal; and output the operating characteristic.

The control system of any preceding clause, further comprising: a controller having one or more memory devices and one or more processors configured to: receive the operating characteristic output from the pyrometer; and perform a control action based at least in part on the operating characteristic of the target.

The control system of any preceding clause, wherein in performing the control action based at least in part on the operating characteristic of the target, the one or more processors of the controller are configured to: control the target or a system associated with the target based at least in part on the operating characteristic of the target; and/or store the operating characteristic of the target and perform lifing and/or prognostic health management of the target and/or system associated with the target.

A control system for a gas turbine engine, the control system comprising: a pyrometer having a detector and a calculation module having one or more processors configured to: receive an output signal from the detector, the output signal having alternating target pulse widths and null widths and being generated by the detector as a target is rotated about an axis of rotation, the target having target elements spaced from one another; and determine an operating characteristic of the target based at least in part on one or more amplitudes of the target pulse widths and one or more amplitudes of the null widths of the output signal.

A gas turbine engine defining a circumferential direction, the gas turbine engine comprising: an airfoil array having a plurality of airfoils spaced from one another along circumferential direction; a pyrometer oriented relative to the airfoil array so that, as the airfoil array is rotated about the circumferential direction, a field of view of the pyrometer alternately engages and does not engage the airfoils, the pyrometer having a detector and a calculation module having one or more processors configured to: receive an output signal from the detector, the output signal having alternating target pulse widths and null widths and being generated by the detector as the airfoil array is rotated about the circumferential direction, the target pulse widths corresponding to period of time in which the detector senses one of the airfoils and the null widths corresponding to periods of time in which the detector does not sense one of the airfoils; and determine an operating characteristic of the airfoil array based at least in part on one or more amplitudes of the target pulse widths and one or more amplitudes of the null widths of the output signal.

A method, comprising: rotating an airfoil array of a gas turbine engine about an axis of rotation, the airfoil array having airfoils that spaced from one another; generating, by a pyrometer as the airfoil array is rotated about the axis of rotation, an output signal having alternating target pulse widths and null widths; and determining an operating characteristic of the airfoil array based at least in part on one or more amplitudes of the target pulse widths and one or more amplitudes of the null widths of the output signal.

The method of any preceding clause, further comprising: orienting the pyrometer relative to the airfoil array so that, as the airfoil array is rotated about the axis of rotation, a field of view of the pyrometer alternately engages and does not engage the airfoils, the target pulse widths being generated by the pyrometer when the field of view of the pyrometer engages one of the airfoils and the null widths being generated by the pyrometer when the field of view of the pyrometer does not engage any of the airfoils.

The method of any preceding clause, wherein the operating characteristic of the airfoil array is a temperature of the airfoil array, and wherein determining the temperature of the airfoil array based at least in part on the one or more amplitudes of the target pulse widths and the one or more amplitudes of the null widths of the output signal comprises: determining a difference between an amplitude of a first null width of the null widths and an amplitude of a first target pulse width of the target pulse widths that is adjacent the first null width, the difference indicating the temperature of the airfoil array.

The method of any preceding clause, wherein the operating characteristic of the airfoil array is a rotational speed of the airfoil array, and wherein determining the rotational speed of the airfoil array based at least in part on the one or more amplitudes of the target pulse widths and the one or more amplitudes of the null widths of the output signal comprises: implementing a Fast Fourier Transform (FFT) to convert the output signal into a frequency domain signal; determining a frequency of the frequency domain signal that corresponds with a pulse of interest that has an amplitude greater than a predetermined magnitude; and determining the rotational speed of the airfoil array based at least in part on the frequency.

The method of any preceding clause, wherein the operating characteristic of the airfoil array is a rotational speed of the airfoil array, and wherein determining the rotational speed of the airfoil array based at least in part on the one or more amplitudes of the target pulse widths and the one or more amplitudes of the null widths of the output signal comprises: counting a number of the target pulse widths and/or a number of null widths that occur within a defined time period; and determining the rotational speed of the airfoil array based at least in part on the number of the target pulse widths and/or the number of null widths that occur within the defined time period.

We claim:

1. A method, comprising:
generating, by a pyrometer as a target having target elements spaced from one another is rotated about an axis of rotation, an output signal having alternating target pulse widths and null widths;
determining an operating characteristic of the target based at least in part on one or more amplitudes of the target pulse widths and one or more amplitudes of the null widths of the output signal; and
performing a control action based at least in part on the operating characteristic of the target.

2. The method of claim 1, further comprising:
orienting the pyrometer relative to the target so that, as the target is rotated about the axis of rotation, a field of view of the pyrometer alternately engages and does not engage the target elements, the target pulse widths being generated by the pyrometer when the field of view of the pyrometer engages one of the target elements and the null widths being generated by the pyrometer when the field of view of the pyrometer does not engage one of the target elements.

3. The method of claim 2, wherein the pyrometer is oriented relative to the target such that the field of view of the pyrometer is at least within fifty-five degrees (55°) perpendicular to a surface of interest of a given one of the target elements and so that the field of view of the pyrometer intermittently does not engage any of the target elements as the target is rotated about the axis of rotation.

4. The method of claim 1, wherein the operating characteristic of the target is a temperature of the target, and wherein determining the temperature of the target based at least in part on the one or more amplitudes of the target pulse widths and the one or more amplitudes of the null widths of the output signal comprises:
determining a difference between an amplitude of a first null width of the null widths and an amplitude of a first target pulse width of the target pulse widths that is adjacent the first null width, the difference indicating the temperature of the target.

5. The method of claim 4, wherein the amplitude of the first target pulse width is taken as at least one of an average amplitude of the first target pulse width, a maximum amplitude of the first target pulse width, a minimum amplitude of the first target pulse width, or a median amplitude of the first target pulse width.

6. The method of claim 1, wherein the operating characteristic of the target is a temperature of the target, and wherein determining the temperature of the target based at least in part on the one or more amplitudes of the target pulse widths and the one or more amplitudes of the null widths of the output signal comprises:
determining a first difference between an amplitude of a first null width of the null widths and a first amplitude of a first target pulse width of the target pulse widths that is adjacent the first null width, the first difference indicating the temperature of a trailing edge of a first target element of the target; and
determining a second difference between the amplitude of the first null width and a second amplitude of the first target pulse width, the second difference indicating the temperature of a leading edge of the first target element of the target.

7. The method of claim 1, wherein the operating characteristic of the target is a rotational speed of the target, and wherein determining the rotational speed of the target based at least in part on the one or more amplitudes of the target pulse widths and the one or more amplitudes of the null widths of the output signal comprises:
implementing a Fast Fourier Transform (FFT) to convert the output signal into a frequency domain signal;
determining a frequency of the frequency domain signal that corresponds with a pulse of interest that has an amplitude greater than a predetermined magnitude; and
determining the rotational speed of the target based at least in part on the frequency.

8. The method of claim 7, wherein determining the rotational speed of the target based at least in part on the one or more amplitudes of the target pulse widths and the one or more amplitudes of the null widths of the output signal comprises:
counting a number of the target pulse widths and/or a number of null widths that occur within a defined time period; and
determining the rotational speed of the target based at least in part on the number of the target pulse widths and/or the number of null widths that occur within the defined time period.

9. The method of claim 1, further comprising:
implementing a target pulse width hold function to hold an amplitude of one of the target pulse widths; and
implementing a null width hold function to hold an amplitude of one of the null widths, and
wherein the operating characteristic of the target is determined based at least in part on the amplitude of the one target pulse width held by the target pulse width hold function and the amplitude of the one null width held by the null width hold function.

10. The method of claim 1, wherein the target is an array of a gas turbine engine and the target elements are airfoils of the array.

11. The method of claim 1, wherein the target elements are arranged so that, for each adjacent pair of the target elements, a leading edge of a first target element of the adjacent pair overlaps with a trailing edge of a second target element of the adjacent pair along a circumferential direction defined by the target.

12. The method of claim 1, wherein the target elements are arranged so that a greatest length of each target element extends along a circumferential direction defined by the target, the target being rotatable about the circumferential direction.

13. The method of claim 1, wherein performing the control action based at least in part on the operating characteristic of the target comprises controlling the target or a system associated with the target based at least in part on the operating characteristic of the target.

14. The method of claim 1, wherein performing the control action based at least in part on the operating characteristic of the target comprises:
storing the operating characteristic of the target in one or more memory devices; and
performing lifing and/or prognostic health management of the target and/or system associated with the target.

15. A non-transitory computer readable medium comprising computer-executable instructions, which, when executed by one or more processors, cause the one or more processors to:
receive an output signal having alternating target pulse widths and null widths, the output signal being generated by a pyrometer as a target is rotated about an axis of rotation, the target having target elements spaced from one another;
determine an operating characteristic of the target based at least in part on one or more amplitudes of the target pulse widths and one or more amplitudes of the null widths of the output signal; and
output the operating characteristic.

16. The non-transitory computer readable medium of claim 15, wherein the target has a plurality of baseline elements that alternate with the target elements, the baseline elements having a lower emissivity than the target elements.

17. The non-transitory computer readable medium of claim 15, wherein the pyrometer is oriented relative to the target so that, as the target is rotated about the axis of rotation, a field of view of the pyrometer alternately engages and does not engage the target elements, the target pulse widths being generated by the pyrometer when the field of view of the pyrometer engages one of the target elements and the null widths being generated by the pyrometer when the field of view of the pyrometer does not engage one of the target elements.

18. A control system for a gas turbine engine, the control system comprising:
a pyrometer having a detector and a calculation module having one or more processors configured to:
receive an output signal from the detector, the output signal having alternating target pulse widths and null widths and being generated by the detector as a target is rotated about an axis of rotation, the target having target elements spaced from one another, the pyrometer is oriented relative to the target so that, as the target is rotated about the axis of rotation, a field of view of the pyrometer alternately engages and does not engage the target elements, the target pulse widths being generated by the pyrometer when the field of view of the pyrometer engages one of the target elements and the null widths being generated by the pyrometer when the field of view of the pyrometer does not engage one of the target elements;
determine an operating characteristic of the target based at least in part on one or more amplitudes of the target pulse widths and one or more amplitudes of the null widths of the output signal; and
output the operating characteristic.

19. The control system of claim 18, further comprising:
a controller having one or more memory devices and one or more processors configured to:
receive the operating characteristic output from the pyrometer; and
perform a control action based at least in part on the operating characteristic of the target.

20. The control system of claim 19, wherein in performing the control action based at least in part on the operating characteristic of the target, the one or more processors of the controller are configured to:
control the target or a system associated with the target based at least in part on the operating characteristic of the target; and/or
store the operating characteristic of the target and perform lifing and/or prognostic health management of the target and/or system associated with the target.
